(19) United States
(12) Patent Application Publication
(10) Pub. No.: US 2016/0234756 A1
(43) Pub. Date: Aug. 11, 2016

(54) METHOD, APPARATUS, AND COMPUTER PROGRAM PRODUCT FOR SIGNALING TRANSMISSION DELAY

(71) Applicant: Nokia Technologies Oy, Espoo (FI)

(72) Inventors: Olli ALANEN, Vantaa (FI); Jarkko KNECKT, Espoo (FI); Mika KASSLIN, Espoo (FI); Enrico RANTALA, Iittala (FI); Janne MARIN, Espoo (FI)

(21) Appl. No.: 14/616,199

(22) Filed: Feb. 6, 2015

(51) Int. Cl. H04W 48/08; H04W 74/08; H04H 20/71; H04W 4/14; H04L 7/00

(52) U.S. Cl. CPC H04W 48/08; H04W 4/14; H04L 7/0041; H04H 20/71; H04W 74/08; H04W 88/08

(57) ABSTRACT

An example method comprises receiving by an apparatus, a message from an access node, including at least one of a delay value indicating a duration to wait before beginning to contend for access to the wireless network by a random backoff procedure to get a transmission opportunity, and an indication whether or not the apparatus is to use a predefined delay value to wait before beginning to contend for access; determining whether to use the delay value to wait before beginning to contend for access to the wireless network; waiting for a duration represented by the delay value, when the apparatus has data to transmit over the wireless network; and beginning to contend for access to the wireless network by a random backoff procedure after the wait duration, before initiating transmission.

### FIELD

The field of technology relates to wireless communication and more particularly to signaling mechanisms for wireless networks.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970s to early 1980s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long range communication networks, like GSM, are a well-accepted means for transmitting and receiving data, due to cost, traffic and legislative concerns, these networks may not be appropriate for all data applications.

Short range communication technologies provide communication solutions that avoid some of the problems seen in large cellular networks. Bluetooth™ is an example of a short range wireless technology quickly gaining acceptance in the marketplace. In addition to Bluetooth™ other popular short range communication technologies include Bluetooth™ Low Energy, IEEE 802.11 wireless local area network (WLAN), Wireless USB (WUSB), Ultra Wide-band (UWB), ZigBee (IEEE 802.15.4, IEEE 802.15.4a), and ultra high frequency radio frequency identification (UHF RFID) technologies. All of these wireless communication technologies have features and advantages that make them appropriate for various applications.

### SUMMARY

Method, apparatus, and computer program product embodiments are disclosed for signaling mechanisms for wireless networks.

An example embodiment of the invention includes a method comprising:

receiving, by an apparatus, a message from an access node managing a wireless network to which the apparatus is associated, the message including at least one of a delay value indicating a duration to wait before beginning to contend for access to the wireless network by a random backoff procedure to get a transmission opportunity, and an indication whether or not the apparatus is to use a predefined delay value to wait before beginning to contend for access to the wireless network;

determining, by the apparatus, whether to use the delay value to wait before beginning to contend for access to the wireless network, based on at least one of a type of the apparatus, a type of service the apparatus performs, and the indication from the access node whether or not the apparatus is to use the delay value;

waiting, by the apparatus, for a duration represented by the delay value, when the apparatus has data to transmit over the wireless network, in response to determining to use the delay value; and

beginning, by the apparatus, to contend for access to the wireless network by a random backoff procedure after the wait duration, before initiating transmission.

An example embodiment of the invention includes a method comprising:

computing, by the apparatus, a randomized delay value based on the received delay value.

An example embodiment of the invention includes a method comprising:

transmitting, by the apparatus, a message to the access node, including an indication that the apparatus has a capability to wait before beginning to contend for access to the wireless network by a random backoff procedure, to get a transmission opportunity.

An example embodiment of the invention includes a method comprising:

wherein the message from the access node is at least one of a broadcast message, groupcast message, unicast message, beacon, probe response, public action frame, wireless network management frame, association response frame, and reassociation response frame.

An example embodiment of the invention includes a method comprising:

determining, by an apparatus managing a wireless network, existence of wireless devices associated with the apparatus, having a capability to wait before beginning to contend for access to the wireless network by a random backoff procedure, to get a transmission opportunity;

computing, by the apparatus, a delay value indicating a duration for wireless devices associated with the apparatus, to wait before beginning to contend for access to the wireless network by a random backoff procedure, to get a transmission opportunity; and

transmitting, by the apparatus, to wireless devices associated with the apparatus in the wireless network, a message including at least one of a delay value indicating a duration to wait before beginning to contend for access to the wireless network by a random backoff procedure, to get a transmission opportunity, and an indication whether or not to use a predefined delay value to wait before beginning to contend for access to the wireless network.

An example embodiment of the invention includes a method comprising:

computing, by the apparatus, the delay value, based on at least one of wireless network load, statistics related to successful transmissions in the wireless network, and service type of the wireless devices associated with the apparatus.

An example embodiment of the invention includes a method comprising:

computing, by the apparatus, a revised delay value, based on at least one of a revised wireless network load and revised statistics related to successful transmissions in the wireless network; and

transmitting, by the apparatus, a message including the revised delay value, to wireless devices associated with the apparatus in the wireless network.

An example embodiment of the invention includes a method comprising:

computing, by the apparatus, the delay value, based at least on providing a fair share of network capacity to wireless devices associated with the apparatus in the wireless network.

An example embodiment of the invention includes an apparatus comprising:

at least one processor;

at least one memory including computer program code;

the at least one memory and the computer program code configured to, with the at least one processor, cause the apparatus at least to:

receive a message from an access node managing a wireless network to which the apparatus is associated, the message including at least one of a delay value indicating a duration to wait before beginning to contend for access to the wireless network by a random backoff procedure to get a transmission opportunity, and an indication whether or not the apparatus is to use a predefined delay value to wait before beginning to contend for access to the wireless network;

determine whether to use the delay value to wait before beginning to contend for access to the wireless network, based on at least one of a type of the apparatus, a type of service the apparatus performs, and the indication from the access node whether or not the apparatus is to use the delay value;

wait for a duration represented by the delay value, when the apparatus has data to transmit over the wireless network, in response to determining to use the delay value; and

begin to contend for access to the wireless network by a random backoff procedure after the wait duration, before initiating transmission.

An example embodiment of the invention includes an apparatus comprising:

the at least one memory and the computer program code configured to, with the at least one processor, cause the apparatus at least to:

compute a randomized delay value based on the received delay value.

An example embodiment of the invention includes an apparatus comprising:

the at least one memory and the computer program code configured to, with the at least one processor, cause the apparatus at least to:

transmit a message to the access node, including an indication that the apparatus has a capability to wait before beginning to contend for access to the wireless network by a random backoff procedure, to get a transmission opportunity.

An example embodiment of the invention includes an apparatus comprising:

wherein the message from the access node is at least one of a broadcast message, groupcast message, unicast message, beacon, probe response, public action frame, wireless network management frame, association response frame, and reassociation response frame.

An example embodiment of the invention includes an apparatus comprising:

at least one processor;

at least one memory including computer program code;

the at least one memory and the computer program code configured to, with the at least one processor, cause the apparatus at least to:

determine existence of wireless devices associated with the apparatus managing a wireless network, having a capability to wait before beginning to contend for access to the wireless network by a random backoff procedure, to get a transmission opportunity;

compute a delay value indicating a duration for wireless devices associated with the apparatus, to wait before beginning to contend for access to the wireless network by a random backoff procedure, to get a transmission opportunity; and

transmit a message including the delay value, to wireless devices associated with the apparatus in the wireless network, the message including at least one of a delay value indicating a duration to wait before beginning to contend for access to the wireless network by a random backoff procedure, to get a transmission opportunity, and an indication whether or not to use a predefined delay value to wait before beginning to contend for access to the wireless network.

An example embodiment of the invention includes an apparatus comprising:

the at least one memory and the computer program code configured to, with the at least one processor, cause the apparatus at least to:

compute the delay value, based on at least one of wireless network load, statistics related to successful transmissions in the wireless network, and service type of the wireless devices associated with the apparatus.

An example embodiment of the invention includes an apparatus comprising:

the at least one memory and the computer program code configured to, with the at least one processor, cause the apparatus at least to:

compute a revised delay value, based on at least one of a revised wireless network load and revised statistics related to successful transmissions in the wireless network; and

transmit a message including the revised delay value, to wireless devices associated with the apparatus in the wireless network.

An example embodiment of the invention includes an apparatus comprising:

the at least one memory and the computer program code configured to, with the at least one processor, cause the apparatus at least to:

compute the delay value, based at least on providing a fair share of network capacity to wireless devices associated with the apparatus in the wireless network.

An example embodiment of the invention includes a program product comprising computer executable program code recorded on a computer readable, non-transitory storage medium, the computer executable program code comprising:

code for receiving, by an apparatus, a message from an access node managing a wireless network to which the apparatus is associated, the message including at least one of a delay value indicating a duration to wait before beginning to contend for access to the wireless network by a random backoff procedure to get a transmission opportunity, and an indication whether or not the apparatus is to use a predefined delay value to wait before beginning to contend for access to the wireless network;

code for determining, by the apparatus, whether to use the delay value to wait before beginning to contend for access to the wireless network, based on at least one of a type of the apparatus, a type of service the apparatus performs, and the indication from the access node whether or not the apparatus is to use the delay value;

code for waiting, by the apparatus, for a duration represented by the delay value, when the apparatus has data to transmit over the wireless network, in response to determining to use the delay value; and

code for beginning, by the apparatus, to contend for access to the wireless network by a random backoff procedure after the wait duration, before initiating transmission.

An example embodiment of the invention includes a program product comprising:

code for transmitting, by the apparatus, a message to the access node, including an indication that the apparatus has a capability to wait before beginning to contend for access to the wireless network by a random backoff procedure, to get a transmission opportunity.

An example embodiment of the invention includes a program product comprising computer executable program code recorded on a computer readable, non-transitory storage medium, the computer executable program code comprising:

code for determining, by an apparatus managing a wireless network, existence of wireless devices associated with the apparatus, having a capability to wait before beginning to contend for access to the wireless network by a random backoff procedure, to get a transmission opportunity;

code for computing, by the apparatus, a delay value indicating a duration for wireless devices associated with the apparatus, to wait before beginning to contend for access to the wireless network by a random backoff procedure, to get a transmission opportunity; and

code for transmitting, by the apparatus, to wireless devices associated with the apparatus in the wireless network, a message including at least one of a delay value indicating a duration to wait before beginning to contend for access to the wireless network by a random backoff procedure, to get a transmission opportunity, and an indication whether or not to use a predefined delay value to wait before beginning to contend for access to the wireless network.

An example embodiment of the invention includes a program product comprising:

code for computing, by the apparatus, the delay value, based on at least one of wireless network load, statistics related to successful transmissions in the wireless network, and service type of the wireless devices associated with the apparatus.

The resulting example embodiments provide signaling mechanisms for wireless networks.

### DESCRIPTION OF THE FIGURES

FIG. 1A is an example network diagram of a wireless network wherein wireless devices are shown transmitting messages to an access node managing the wireless network to which the wireless devices are associated. Each message includes an indication whether or not the wireless device has a capability to wait before beginning to contend for access to the wireless network by a random backoff procedure, to get a transmission opportunity. Some of the wireless devices have the capability and others do not have the capability, in accordance to an example embodiment of the invention.

FIG. 1B is the example network diagram of FIG. 1A, wherein the AP determines whether or not the wireless devices or STAs in the wireless network BSS, should delay before actually starting contention to get a transmission opportunity (TXOP) for transmitting data. The access node computes a delay value indicating a duration for wireless devices associated with the access node, to wait before beginning to contend for access to the wireless network by a random backoff procedure, to get a transmission opportunity. Computing the delay value may be based on at least one of wireless network load, statistics related to successful transmissions in the wireless network, and service type of the wireless devices associated with the access node, in accordance to an example embodiment of the invention.

FIG. 1C is the example network diagram of FIG. 1B, wherein the access point or node transmits a message including at least one of an indication whether or not to use the contention delay value and the delay value txopInitDelay, to wireless devices associated with the access node in the wireless network. The message transmitted by the access node may be by broadcast, groupcast, or unicast. The message may be at least one of a beacon, a probe response, a public action frame, an association response frame, a reassociation response frame, or a wireless network management frame, in accordance to an example embodiment of the invention.

FIG. 1D is the example network diagram of FIG. 1C, upon receiving the indication, the relevant STAs determine whether to use the delay value to wait before beginning to contend for access to the wireless network, based on at least one of a type of the apparatus, a type of service the apparatus performs, and the indication from the access node whether or not the apparatus is to use the delay value. For those wireless devices having the capability to wait before beginning to contend for access, each capable wireless device may compute a randomized delay value based on the received information. The capable wireless device waits for a duration represented by the randomized delay value, when the wireless device has data to transmit over the wireless network. Then, the capable wireless device begins to contend for access to the wireless network by a random backoff procedure, before initiating a transmission opportunity, in accordance to an example embodiment of the invention.

FIG. 2 is an example timing diagram illustrating the stages of the capable wireless device determining that it has data to transmit over the wireless network, waiting for a duration represented by the randomized delay value, and then beginning to contend for access to the wireless network by a random backoff procedure, before initiating a transmission opportunity, in accordance to an example embodiment of the invention.

FIG. 3 is an example AID Request message sent by a wireless device, including an indication whether or not the wireless device has a capability to wait before beginning to contend for access to the wireless network by a random backoff procedure, to get a transmission opportunity, in accordance to an example embodiment of the invention.

FIG. 4 is an example illustration comparing timing for wireless devices gaining access to the wireless network depending on whether or not the wireless device has a capability to wait before beginning to contend for access to the wireless network by a random backoff procedure, to get a transmission opportunity, in accordance to an example embodiment of the invention.

FIG. 5A is an example flow diagram of operational steps in a wireless device that has a capability to wait before beginning to contend for access to the wireless network by a random backoff procedure, to get a transmission opportunity, in accordance to an example embodiment of the invention.

FIG. 5B is an example flow diagram of operational steps in the access node that computes a delay value indicating a duration for wireless devices associated with the access node, to wait before beginning to contend for access to the wireless network by a random backoff procedure, to get a transmission opportunity, according to an example embodiment of the invention.

FIG. 6A is an example functional block diagram, illustrating an example wireless device, according to an example embodiment of the invention.

FIG. 6B is an example functional block diagram, illustrating an example access node, according to an example embodiment of the invention.

FIG. 7 illustrates an example embodiment of the invention, wherein examples of removable storage media are shown, in accordance with at least one embodiment of the present invention.

### DISCUSSION OF EXAMPLE EMBODIMENTS OF THE INVENTION

This section is organized into the following topics:

A. WLAN Communication Technology

B. TRANSMISSION OPPORTUNITY INITIATION DELAY

A. WLAN Communication Technology

The IEEE 802.11 standard specifies methods and techniques of an exemplary wireless local area network (WLAN) operation. Examples include the IEEE 802.11b and 802.11g wireless local area network specifications, which have been a staple technology for traditional WLAN applications in the 2.4 GHz ISM band. The various amendments to the IEEE 802.11 standard were consolidated for IEEE 802.11a, b, d, e, g, h, i, j, k, n, r, s, u, v, and z protocols, into the base standard IEEE 802.11-2012, Wireless Medium Access Control (MAC) and Physical Layer (PHY) Specifications, February 2012. Applications of these IEEE 802.11 standards include products such as consumer electronics, telephones, personal computers, and access points for both for home and office.

According to an example embodiment, wireless local area networks (WLANs) typically operate in unlicensed bands. IEEE 802.11b and 802.11g WLANs have been a staple technology for traditional WLAN applications in the 2.4 GHz ISM band and have a nominal range of 100 meters. The IEEE 802.11ah WLAN standard is being developed for operation below 1 GHz and will have a greater range and lower obstruction losses due to its longer wavelength.

According to an example embodiment, an IEEE 802.11 WLAN may be organized as an independent basic service set (IBSS) or an infrastructure basic service set (BSS). The access point (AP) in an infrastructure basic service set (BSS) IEEE 802.11 WLAN network, may be a central hub that relays all communication between the mobile wireless devices (STAs) in an infrastructure BSS. If a STA in an infrastructure BSS wishes to communicate a frame of data to a second STA, the communication may take two hops. First, the originating STA may transfer the frame to the AP. Second, the AP may transfer the frame to the second STA. In an infrastructure BSS, the AP may transmit beacons or respond to probes received from STAs. After a possible authentication of a STA that may be conducted by the AP, an association may occur between the AP and a STA enabling data traffic to be exchanged with the AP. The Access Point (AP) in an Infrastructure BSS may bridge traffic out of the BSS onto a distribution network. STAs that are members of the BSS may exchange packets with the AP.

According to an example embodiment, the IEEE 802.11 WLAN may use two types of transmission: Distributed Coordination Function (DCF) and Point Coordination Function (PCF). DCF employs Carrier Sense Multiple Access with Collision Avoidance (CSMA/CA). A packet sent may be positively acknowledged by the receiver. A transmission may begin with a Request-to-send (RTS) and the receiver may respond with a Clear-to-send (CTS). The channel may be cleared by these two messages, since all other STAs that hear at least one of the CTS and the CTS may suppress their own start of a transmission. The Request-to-send (RTS) packet sent by the sender and the Clear-to-send (CTS) packet sent in reply by the intended receiver, may alert all other devices within range of the sender or the receiver, to refrain from transmitting for the duration of the main packet.

According to an example embodiment, when data packets are transmitted, each may have a Network Allocation Vector (NAV) containing a duration value to reserve the channel for the sender and receiver for an interval after the current packet, equal to the NAV duration. The network allocation vector (NAV) is an indicator that may be maintained by each STA, of time periods when transmission onto the wireless medium will not be initiated by the STA whether or not the STA's physical carrier sensing function senses that the medium is busy. Use of the NAV for carrier sensing is called virtual carrier sensing. STAs receiving a valid frame may update their NAV with the information received in the duration field for all frames where the new NAV value is greater than the current NAV value, including the RTS and CTS packets, as well data packets. The value of the NAV decrements with the passage of time. Once the sender and receiver have reserved the channel, they may hold it for the remaining duration of the NAV value. The last acknowledgement packet (ACK) contains a NAV value of zero, to release the channel.

According to an example embodiment, standard spacing intervals are defined in the IEEE 802.11 specification, which delay a station's access to the medium, between the end of the last symbol of the previous frame and the beginning of the first symbol of the next frame. The short interframe space (SIFS), the shortest of the interframe spaces, may allow acknowledgement (ACK) frames and clear-to-send (CTS) frames to have access to the medium before others. The longer duration distributed coordination function (DCF) interframe space (IFS) or DIFS interval may be used for transmitting data frames and management frames.

According to an example embodiment, after the channel has been released, IEEE 802.11 wireless devices normally employ a spectrum sensing capability during the SIFS interval or DIFS interval, to detect whether the channel is busy. A carrier sensing scheme may be used wherein a node wishing to transmit data has to first listen to the channel for a predetermined amount of time to determine whether or not another node is transmitting on the channel within the wireless range. If the channel is sensed to be idle, then the node may be permitted to begin the transmission process. If the channel is sensed to be busy, then the node may delay its transmission for a random period of time called the backoff interval. In the DCF protocol used in IEEE 802.11 networks, the stations, on sensing a channel idle for DIFS interval, may enter the backoff phase with a random value between 0 and CWmin. The backoff counter may be decremented from this selected value as long as the channel is sensed idle.

According to an example embodiment, an algorithm, such as binary exponential backoff, may be used to randomly delay transmissions, in order to avoid collisions. The transmission may be delayed by an amount of time that is the product of the slot time and a pseudo random number. Initially, each sender may randomly wait 0 or 1 slot times. After a busy channel is detected, the senders may randomly wait between from 0 to 3 slot times. After the channel is detected to be busy a second time, the senders may randomly wait between from 0 to 7 slot times, and so forth. As the number of transmission attempts increases, the number of random possibilities for delay increases exponentially. An alternate backoff algorithm is the truncated binary exponential backoff, wherein after a certain number of increases, the transmission timeout reaches a ceiling and thereafter does not increase any further.

A terminal device may associate or register with an access point to gain access to the network managed by the access point. Association allows the access point to record each terminal device in its network so that frames may be properly delivered. After the terminal device authenticates to the access point, it sends an association request to the access point. Association allows the access point to record each terminal device so that frames may be properly delivered. The association request is a management frame that contains information describing the terminal device, such as its capability, listening interval, SSID, supported rates, power capability, QoS capability, and the like. The access point processes the association request and grants association by replying with an association response frame. The association response frame is a management frame that contains information describing the access point, such as its capability and supported rates. The association response frame also includes an association ID (AID) that is assigned by the access point to identify the terminal device for delivery of buffered frames. The AID field is a value assigned by the access point during association, which represents the 16-bit ID of a terminal device. The length of the AID field is two octets, the value assigned as the AID is in the range 1-2007, and it is placed in the 14 lowest significant bits (LSBs) of the AID field, with the two most significant bits (MSBs) of the AID field each set to “1”.

An access point may maintain a polling list for use in selecting terminal devices in its network, which are eligible to receive contention free polls (CF-Polls) during contention free periods. The polling list is used to force the polling of contention free terminal devices capable of being polled, whether or not the access point has pending traffic to transmit to those terminal devices.

Whenever an access point needs to poll a group of terminal devices who already know their respective AIDs within the network that the access point manages, a contention free (CF) group poll message may be sent by the access point.

After receiving contention free (CF) group poll message from the access point, a terminal device in the group that has data to send, transmits a response message or acknowledgement (ACK) to access point, after waiting for a short interframe space (SIFS) interval.

The access point (AP) in an infrastructure BSS assists those mobile wireless devices (STAs) attempting to save power. The legacy IEEE 802.11e Wireless LAN standards provides for support of low power operation in handheld and battery operated STAs, called automatic power save delivery (APSD). A STA capable of APSD and currently in the power saving mode, will wake up at predetermined beacons received from the AP to listen to a Traffic Indication Map (TIM). If existence of buffered traffic waiting to be sent to the STA is signaled through the TIM, the STA will remain awake until AP sends out all the data. The STA does not need to send a polling signal to the AP to retrieve data, which is the reason for the term “automatic” in the acronym APSD.

A Traffic Indication Map (TIM) is a field transmitted in beacon frames, used to inform associated wireless terminal devices or STAs that the access point has buffered data waiting to be transmitted to them. Access points buffer frames of data for STAs while they are sleeping in a low-power state. The access point transmits beacons at a regular interval, the target beacon transmission time (TBTT). The Traffic Indication Map (TIM) information element in the periodically transmitted beacon frame, indicates which STAs have buffered data waiting to be accessed in the access point. Each frame of buffered data is identified by an association identifier (AID) associated with a specific STAs. The AID is used to logically identify the STAs to which buffered frames of data are to be delivered. The traffic indication map (TIM) contains a bitmap, with each bit relating to a specific association identifier (AID). When data is buffered in the access point for a particular association identifier (AID), the bit is “1”. If no data is buffered, the bit for the association identifier (AID) is “0”. Wireless terminal devices must wake up and listen for the periodic beacon frames to receive the Traffic Indication Map (TIM). By examining the TIM, a STAs may determine if the access point has buffered data waiting for it. To retrieve the buffered data, the STAs may use a power-save poll (PS-Poll) frame. After transmitting the PS-Poll frame, the client mobile station may stay awake until it receives the buffered data or until the bit for its association identifier (AID) in the Traffic Indication Map (TIM) is no longer set to “1”, indicating that the access point has discarded the buffered data.

Two variations of the APSD feature are unscheduled automatic power save delivery (U-APSD) and scheduled automatic power save delivery (S-APSD). In U-APSD, the access point (AP) is always awake and hence a mobile wireless device (STA) in the power save mode may send a trigger frame to the AP when the STA wakes up, to retrieve any queued data at the AP. In S-APSD, the AP assigns a schedule to a STA and the STA wakes up, sends a power save poll packet to the AP in order to retrieve from the AP any data queued. An AP may maintain multiple schedules either with the same STA or with different STAs in the infrastructure BSS network. Since the AP is never in sleep mode, an AP will maintain different scheduled periods of transmission with different STAs in the infrastructure BSS network to ensure that the STAs get the maximum power savings.

The IEEE 802.11 enhanced distributed channel access (EDCA) contention access is an extension of the CSMA/CA mechanism to include priorities. The contention window and backoff times in CSMA/CA are adjusted to change the probability of a STA gaining medium access to favor higher priority classes. Each priority is mapped to one of four access categories (AC). Under EDCA, STAs use the same CSMA/CA access mechanism and contend on an equal basis at a given priority. A STA that wins an EDCA contention is granted a transmission opportunity (TXOP), which is the right to use the medium for a period of time. The duration of this TXOP is specified for each access category. A STA may use a TXOP to transmit multiple frames within an access category. If the frame exchange sequence has been completed and there is still time remaining in the TXOP, the STA may extend the frame exchange sequence by transmitting another frame in the same access category. The STA ensures that the transmitted frame and any necessary ACK can fit into the time remaining in the TXOP.

The network allocation vector (NAV) is an indicator of time periods when transmission onto the wireless medium will not be initiated by a STA. STAs receiving a valid frame will update their NAV with the information received in the duration field T for all frames where the new NAV value is greater than the current NAV value, including the RTS and CTS packets, as well data packets. RTS effectively prevents other STAs within the coverage area from transmitting during the TXOP. CTS effectively prevents other STAs within the coverage area from transmitting during the TXOP.

The IEEE 802.11ah WLAN standard operating below 1 GHz, has a greater range and lower obstruction losses due to its longer wavelength. IEEE 802.11ah provides wireless LAN operation in the sub-1 GHz range considered appropriate for sensor networks, machine-to-machine, cellular offload, and smart grid applications. IEEE 802.11ah defines three use case categories:

Use Case 1: Sensors and meters;

Use Case 2: Backhaul sensor and meter data; and

Use Case 3: Extended range Wi-Fi

A principal application of IEEE 802.11ah is sensor networks, for example in smart metering, where the measurement information at each sensor node may be transmitted to an access point. In example sensor applications, the data packet size may be a few hundred bytes, the sensors may have a low duty-cycle, transmitting data every few minutes, and the number of sensor devices may be as large as 6000 devices communicating with an access point. Due to the large range and the high number of stations in the network, hidden nodes pose a major problem in the operation of the 802.11ah networks.

The IEEE 802.11ah WLAN standard has support to organize the STAs associated to a network, into groups. The association response frame transmitted by the access point device, may indicate a group ID, along with the conventional association ID (AID) field that associates the STA to the access point. The group IDs may be numbered in descending order of group priority for quality of service (QoS) STAs. The access point may base its group ID number for the case of non-QoS STAs on their respective association times. In this manner, the access point may determine which STAs are members of which group. Based on the association request frame from a new requesting STA, the access point either uses QoS parameters or non-QoS parameters, such as proximity and location in a sector of the access point, to decide to which group the new STA is a member. The corresponding group ID of the group to which the new STA is assigned is then sent by the access point to the STA in response to the association request message. The association response frame indicates the group ID, along with the conventional AID field that associates the STA to the access point.

B. Transmission Opportunity Initiation Delay

Current 802.11 operation might not be the most optimal for low-power devices. When there are many low-power devices that have very infrequent traffic, such as for merely sending uplink sensor data with a large periodicity, the standard backoff procedure may be inefficient. Small contention window values may result in low power consumption, but they may also create many collisions if a large number of devices compete for channel access. On the other hand, if contention window parameters are relaxed, there may be fewer collisions, but the devices must perform the backoff for a long period before the transmissions, which will increase the power consumption, since the STAs cannot operate in the doze while performing the backoff.

In accordance with an example embodiment of the invention, an access point device may signal to client stations or wireless devices, a value indicating how long the wireless devices should delay before actually starting contention to get a transmission opportunity (TXOP) for transmitting data. This value may be the actual delay, but other implementations are possible, as well. As an example, an AP may give the upper limit of the delay, or an AP may give a pointer to a range of delay values and the ranges are defined, for example, in a specification. Alternately, the delay may be dependent on the device type and an AP may simply indicate whether or not to apply the delay. With this delay in the TXOP initiation, the access point may adjust the network load and avoid unnecessary collisions, to reduce overall power consumption for the wireless devices.

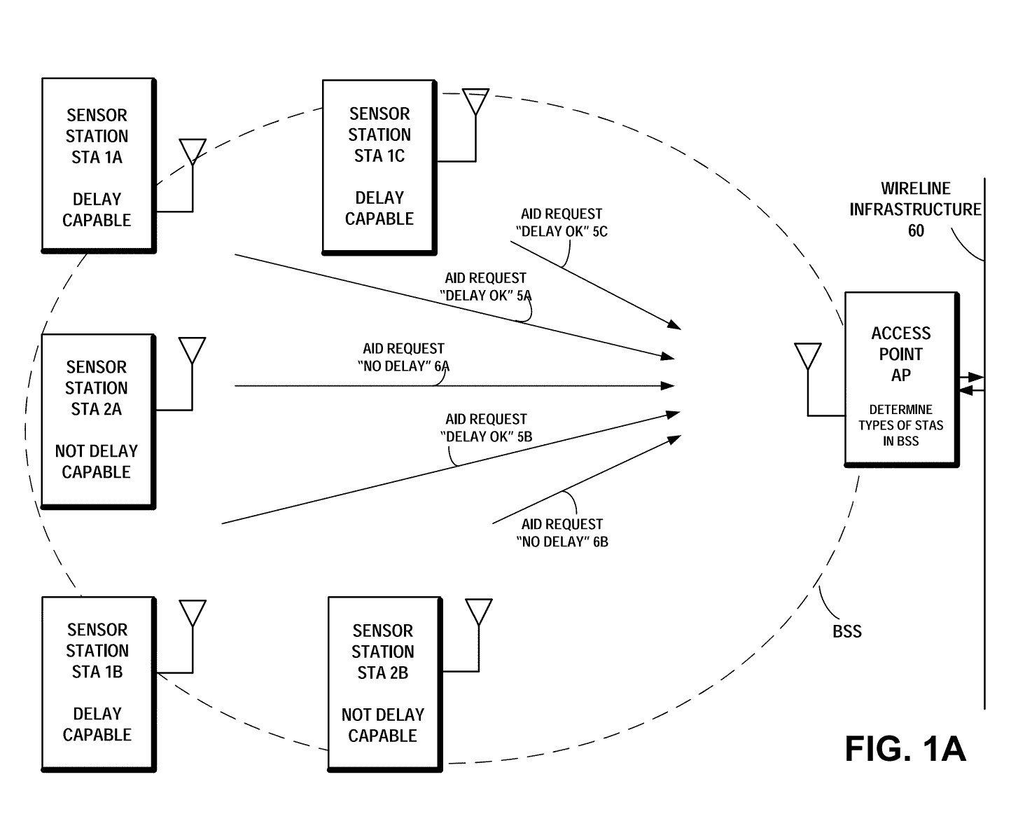

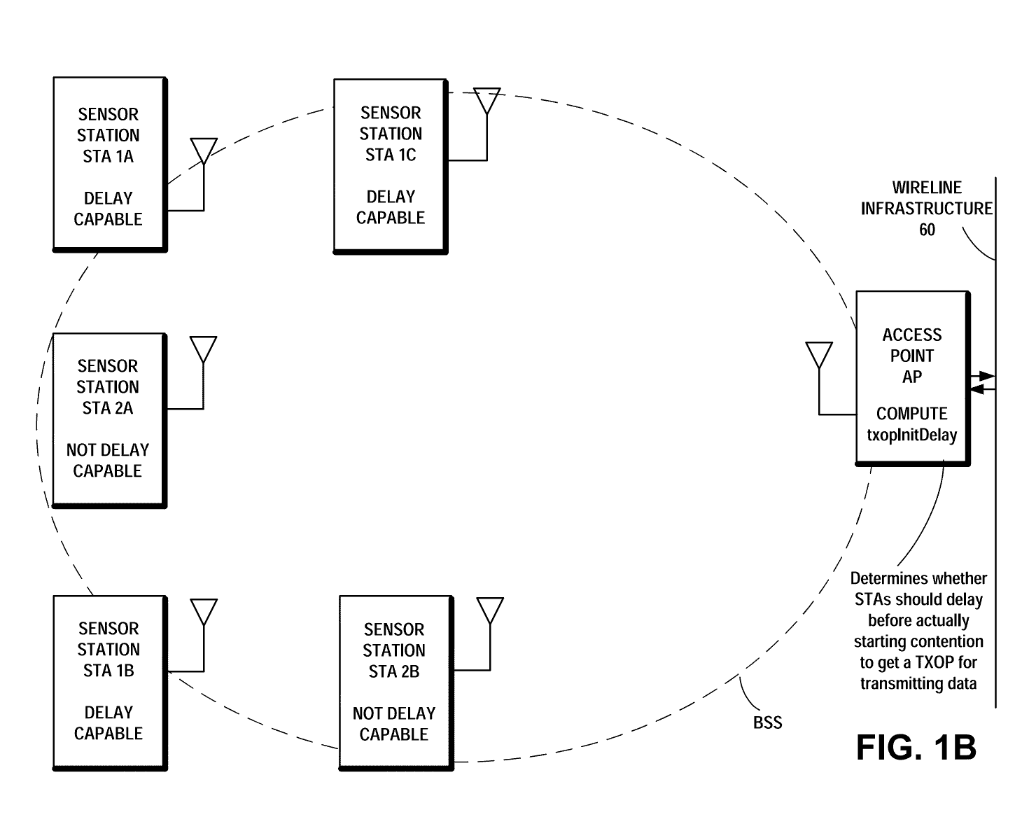

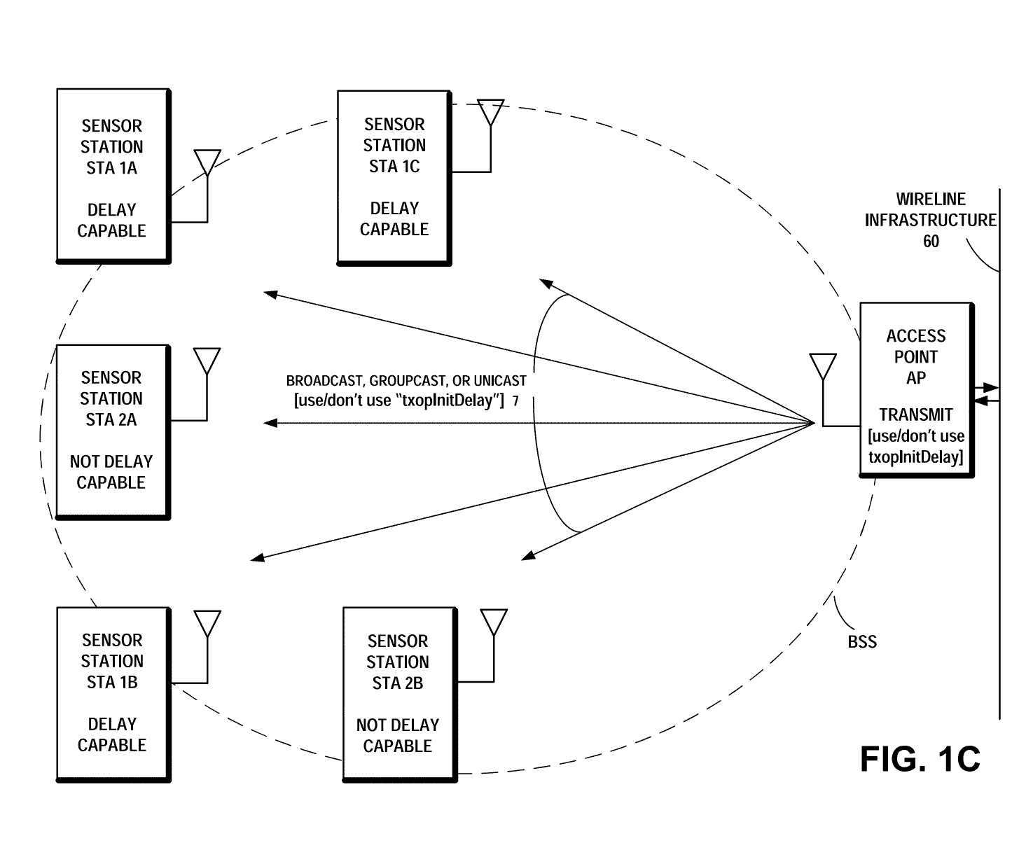

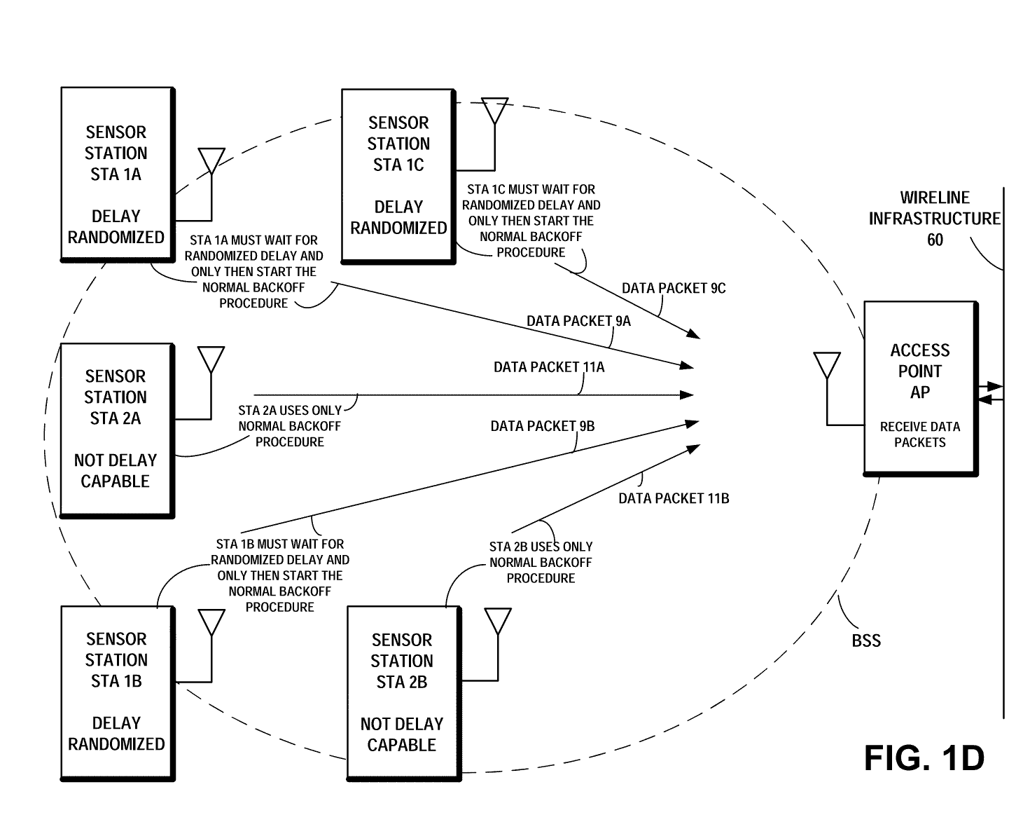

FIG. 1A is an example network diagram of a wireless network BSS, wherein wireless devices 1A, 1B, 1C and 2A, 2B are shown transmitting messages 5A, 5B, 5C and 6A, 6B to an access point or node AP managing the wireless network to which the wireless devices 1A, 1B, 1C and 2A, 2B are associated. Each message includes an indication whether or not the wireless device has a capability to wait before beginning to contend for access to the wireless network by a random backoff procedure, to get a transmission opportunity. Some of the wireless devices 1A, 1B, 1C have the capability and others 2A, 2B do not have the capability, in accordance to an example embodiment of the invention.

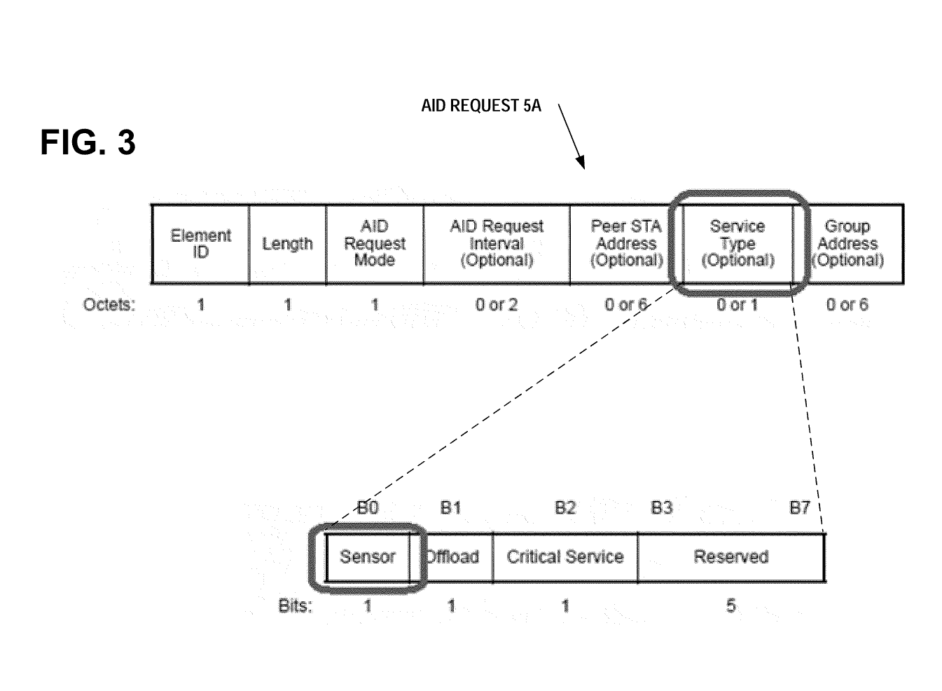

IEEE 802.11ah defines the usage of Service Type Field (FIG. 3). In accordance with an example embodiment of the invention, the same Service Type Field may be attached to association request messages 5A, 5B, 5C and 6A, 6B to let wireless devices 1A, 1B, 1C and 2A, 2B inform the AP as to which kind of service are they offering. The AP should know the type of the wireless device, to be able to decide which parameters to provide. For that purpose, the service type field in the 802.11ah AID request message of FIG. 3 may be used. The service type field content is presented in the FIG. 3, in which the first bit may be used to indicate whether or not the wireless device is a sensor station STA. Also, the other fields of the Service Type Field of FIG. 3 may be utilized to identify need for the delay value, txopInitDelay, indicating a duration to wait before beginning to contend for access to the wireless network by a random backoff procedure, to get a transmission opportunity. The field is currently defined only for IEEE 802.11ah.

FIG. 1B is the example network diagram of FIG. 1A, wherein the AP determines whether or not the wireless devices or STAs in the wireless network BSS, should delay before actually starting contention to get a transmission opportunity (TXOP) for transmitting data. There are circumstances, for example a minimal network traffic condition, under which the contention delay mechanism need not be applied. The following are some example factors that the AP may consider in making the determination.

In an example embodiment of the invention, the AP first determines whether contention should be delayed and only after making that determination, does the AP signal the result to the STA(s). The AP may assign contention delay to be used by:

a) all the capable STAs associated to the AP;

b) only to a certain set of STAs associated to the AP (e.g. based on device or service type of the STA); or

c) a dedicated STA.

In an example embodiment of the invention, once the AP has determined that at least some STAs should delay before starting contention, the AP may use available signaling to indicate to the relevant STAs whether or not they should use the contention delay. The signaling for delay contention may be by broadcast, groupcast, or unicast.

In an example embodiment of the invention, the AP may indicate in the signaling, either separately on in a combined indicator, whether the contention delay is to be applied and what duration of the delay is to be used. As an example, an AP may merely indicate to all STAs or a relevant subset of STAs whether the contention delay is to be applied.

In an example embodiment of the invention, upon receiving the indication, the relevant STAs determine without any further signaling or indication from the AP, what is the delay value they need to use. In an example embodiment, the STAs may determine the delay value based on the STA's type and/or the type the service it performs. In an example embodiment, the STAs may be indicated to use a predefined delay value that is defined in a relevant specification. The specification may define predefined values for each STA type and/or service type.

In an example embodiment of the invention, the STA may need to randomize the delay value it receives from the AP. In other example embodiments, randomization may not be necessary. In an example embodiment, the delay value the STA receives from the AP represents the maximum delay value and the STA picks up the actual delay value for use by randomly selecting a value from a value range with the upper limit equal to the maximum delay value.

In an example embodiment of the invention, an AP may indicate the delay value, as described, and some specific value such as ‘0’, which means that the contention delay is not to be used.

In an example embodiment of the invention, the access point or node AP computes a delay value txopInitDelay, indicating a duration for wireless devices associated with the access node AP, to wait before beginning to contend for access to the wireless network by a random backoff procedure, to get a transmission opportunity. Computing the delay value txopInitDelay may be based on at least one of wireless network load, statistics related to successful transmissions in the wireless network, and service type of the wireless devices associated with the access node, in accordance to an example embodiment of the invention.

The delay value txopInitDelay is not a randomized value in the example embodiment of the invention and it represents the upper bound of the contention delay for the wireless devices to use. It is only after the capable wireless device receives the delay value txopInitDelay, when the capable wireless device computes a randomized delay value based on the received delay value txopInitDelay.

Example AP logic to adjust the txopInitDelay: may be based on several criteria:
BSS Load (includes number of associated STAs and channel utilization);
Statistics related to the successful transmissions;
Service type (only for sensor STAs or to customer who have not paid a priority access to achieve bronze/silver/gold priorities).

In an assumed use case of an AP with many associated low-power Internet of Things, sensor STAs and other WLAN STAs, the AP may keep track of how many sensor STAs are associated with it. The AP may use the service type, presented in the IEEE 802.11ah specification, to identify that a certain STA is a sensor STA.

In case the number of sensor STAs becomes large (more than a threshold) and the collision probability becomes to too high (another threshold), the AP may switch to a new mode of operation. In a similar way, after the number of sensor STAs and the collision percentage have again fallen below the thresholds (plus hysteresis), the AP may switch back to the normal mode of operation.

In the revised operation mode, the AP may use action frames to command all of the associated sensor STAs to utilize a larger value of txopInitDelay. There may, however, still be “normal” STAs associated to the AP, and the command should not apply to them. In addition, the AP may provide the higher txopInitDelay value for newly associating sensor STAs.

With this mode of operation, the AP may provide a fair share of the capacity for each STA by setting the txopInitDelay, accordingly. Assume that there are 100 sensor STAs associated to the AP. Also assume that the AP wants to make sure that all of the STAs will have a chance to use their 1% of the channel, while still operating most of the time in the sleep state. In this case, the AP may, for example, set the parameters as follows:

| Device Type: | Sensor STA | Normal STA |
|---|---|---|
| TXOP Limit | 1.0 ms | 2.0 ms |
| CWmin | 15 | 63 |
| CWmax | 63 | 511 |
| txopInitDelay | 200.0 ms | 0 ms |

These parameters should result in long term the sensor STAs utilizing less than 1% of the channel, if there is not much other traffic. This should reduce the number of simultaneously competing STAs to a very low value. Since the sensor STA CW parameters are also set quite low, they will access the channel quickly after the contention delay derived from the txopInitDelay, but they may then again wait on average at least 100 ms before re-accessing the channel.

In accordance with an example embodiment of the invention, the capability of a STA is not necessarily a one-to-one mapping to whether or not the access node sets the txopInitDelay for those STAs. The access node may or may not set the txopInitDelay for capable STAs. It may also set the delay only for some of the capable STAs.

FIG. 1C is the example network diagram of FIG. 1B, wherein the access point or node transmits a message 7 including at least one of an indication whether or not to use the contention delay value and the delay value txopInitDelay, to wireless devices associated with the access node in the wireless network. The message 7 transmitted by the access node may be by broadcast, groupcast, or unicast. If by broadcast, the message 7 may be at least one of a beacon, a probe response, a public action frame, an association response frame, a reassociation response frame, or a wireless network management frame, in accordance to an example embodiment of the invention.

There are at least two ways to signal the value of txopInitDelay from the AP to the STAs. One is to extend the EDCA Parameter Set to also contain txopInitDelay. The second one is to create a new information element to contain the txopInitDelay. The new information element or the EDCA Parameter Set may contain the value in milliseconds and the service type to which is the value assigned.

The information element may then be included in a beacon, probe response, public action, and (re)association response frames. In addition a new action frame may be defined to be able to change the value of txopInitDelay after the STA has been associated.

The AP may indicate in the signaling, either separately on in a combined indicator, whether the contention delay is to be applied and what duration of the delay is to be used. As an example, an AP may merely indicate to all STAs or a relevant subset of STAs whether the contention delay is to be applied.

FIG. 1D is the example network diagram of FIG. 1C, wherein in an example embodiment of the invention, upon receiving the indication, the relevant STAs determine without any further signaling or indication from the AP, what is the delay value they need to use. In an example embodiment, the STAs may determine the delay value based on the STA's type and/or the type the service it performs. The delay value may be defined in the specification and it may defined for each STA type and/or for each service type. In an example embodiment of the invention, the STA may need to generate a randomized delay value from the delay value it receives from the AP. In other example embodiments, randomization may not be necessary. In an example embodiment of the invention, an AP may indicate the delay value, as described, and some specific value such as ‘0’, which means that the contention delay is not to be used.

Upon receiving the indication, the relevant STAs determine whether to wait before beginning to contend for access to the wireless network, based on at least one of a type of the apparatus, a type of service the apparatus performs, and the indication from the access node whether or not the apparatus is to use the delay value. For those wireless devices having the capability to wait before beginning to contend for access, each capable wireless device may compute a randomized delay value based on the received delay value. Alternatively each capable wireless device may take in use the predefined delay value based on their device type and/or service type. The capable wireless device waits for a duration represented by the randomized delay value, when the wireless device has data to transmit over the wireless network. Then, the capable wireless device begins to contend for access to the wireless network by a random backoff procedure, before initiating a transmission opportunity, in accordance to an example embodiment of the invention.

In an example embodiment of the invention, for those wireless devices 1A, 1B, 1C having the capability to wait before beginning to contend for access, each capable wireless device computes a randomized delay value based on the received delay value txopInitDelay. The capable wireless device waits for a duration represented by the randomized delay value, when the wireless device has data to transmit in a data packet 9A, 9B, 9C over the wireless network. Then, the capable wireless device 1A, 1B, 1C begins to contend for access to the wireless network by a backoff procedure, before initiating a transmission opportunity, in accordance to an example embodiment of the invention.

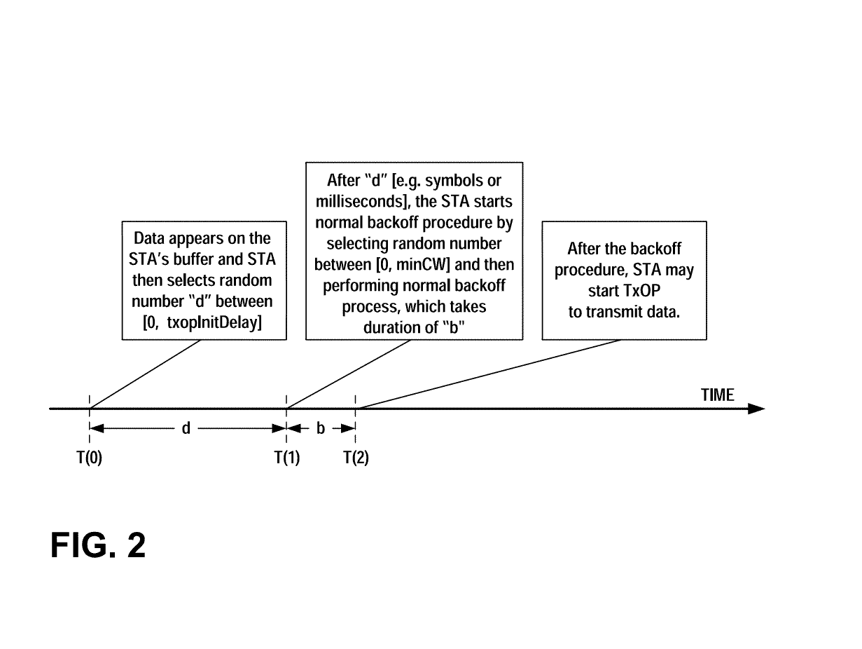

FIG. 2 is an example timing diagram illustrating the stages of the capable wireless device 1A, 1B, 1C determining at time T(0) that it has data to transmit over the wireless network. It waits for a duration represented by the delay value “d” between [0, txopInitDelay]. Alternatively, the delay value “d” may be a predefined value that depends on the device type and/or the type of the service run at the time. The txopInitDelay may be also set to a predefined value that depends on the device type and/or the type of the service run at the time. Then at time T(1) it begins to contend for access to the wireless network by a random backoff procedure, shown as the duration “b” from T(1) to T(2 ), before initiating a transmission opportunity, in accordance to an example embodiment of the invention. After the duration “d” [e.g. symbols or milliseconds], the STA starts a normal backoff procedure by selecting a random number between [0, minCW] and then performing a normal backoff process, which takes a duration of “b”.

In accordance with an example embodiment of the invention, a capable wireless device 1A, 1B, 1C may perform the steps of:

1. Wait for the delay [0, txopInitDelay];

2. Begin the backoff based contention; and

3. When the competition is done/won, begin the transmission opportunity by sending, for example, data.

FIG. 3, as discussed above, is an example AID Request message 5A sent by a wireless device 1A, including an indication whether or not the wireless device has a capability to wait before beginning to contend for access to the wireless network by a random backoff procedure, to get a transmission opportunity, in accordance to an example embodiment of the invention.

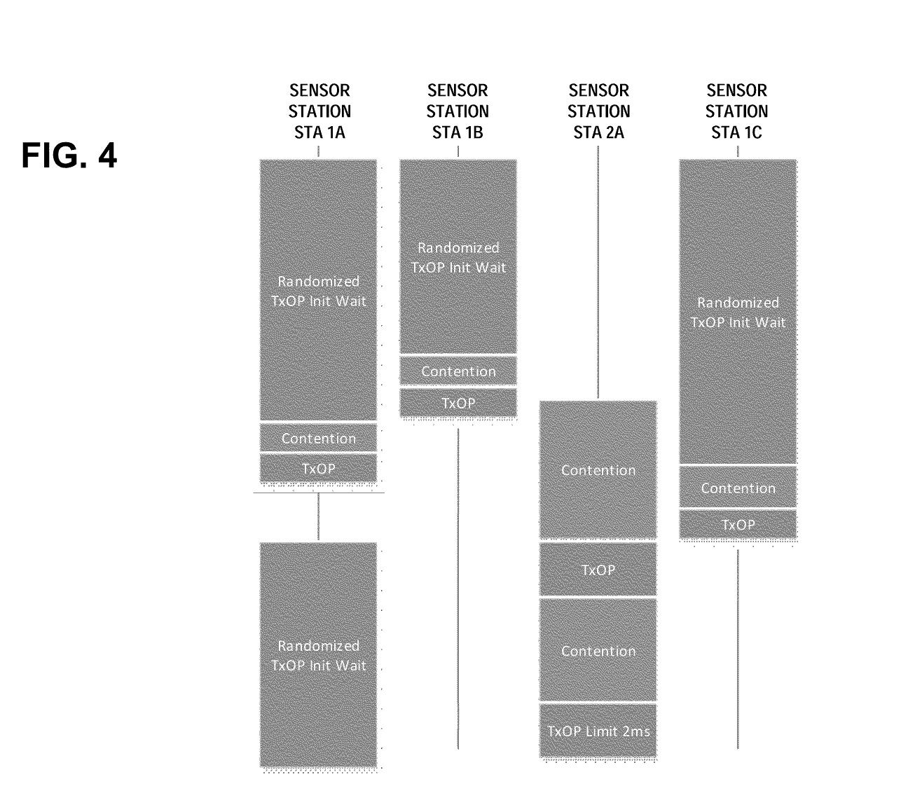

FIG. 4 is an example illustration comparing timing for wireless devices 1A, 1B, 1C and for wireless device 2A, for gaining access to the wireless network, depending on whether or not the wireless device has a capability to wait before beginning to contend for access to the wireless network by a random backoff procedure, to get a transmission opportunity, in accordance to an example embodiment of the invention. The wireless devices 1A, 1B, 1C have the capability and the normal wireless device 2A does not have the capability. Normal STA 2A may most likely have to wait for the sensor data of wireless devices 1A, 1B, 1C to be transmitted, before entering the channel, but on the other hand normal STA 2A may get the next TXOP limit quickly thereafter.

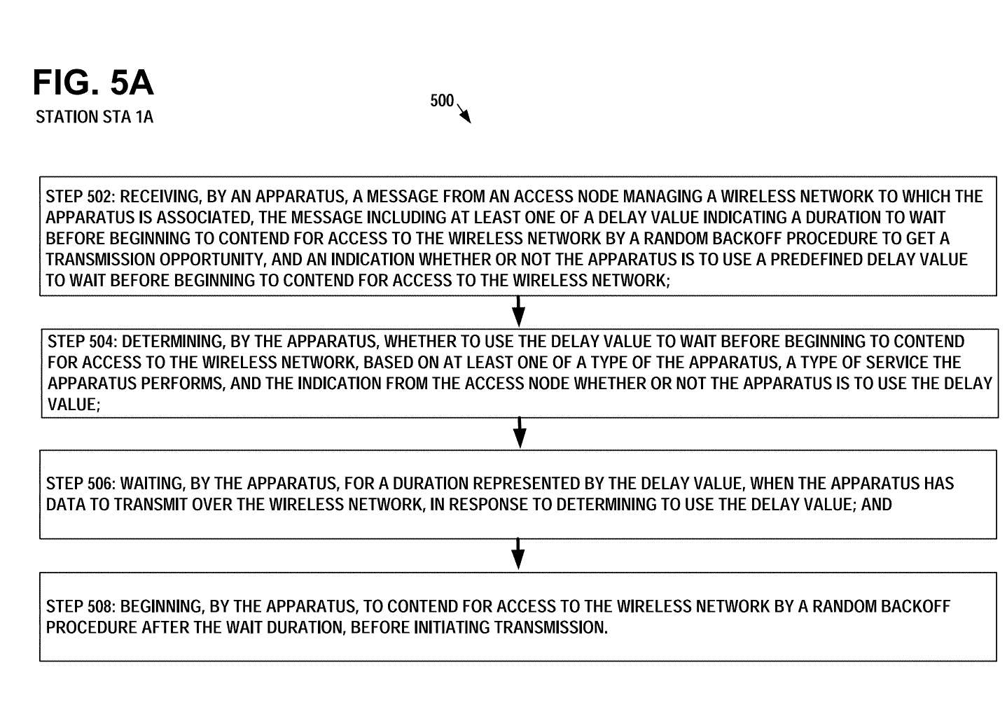

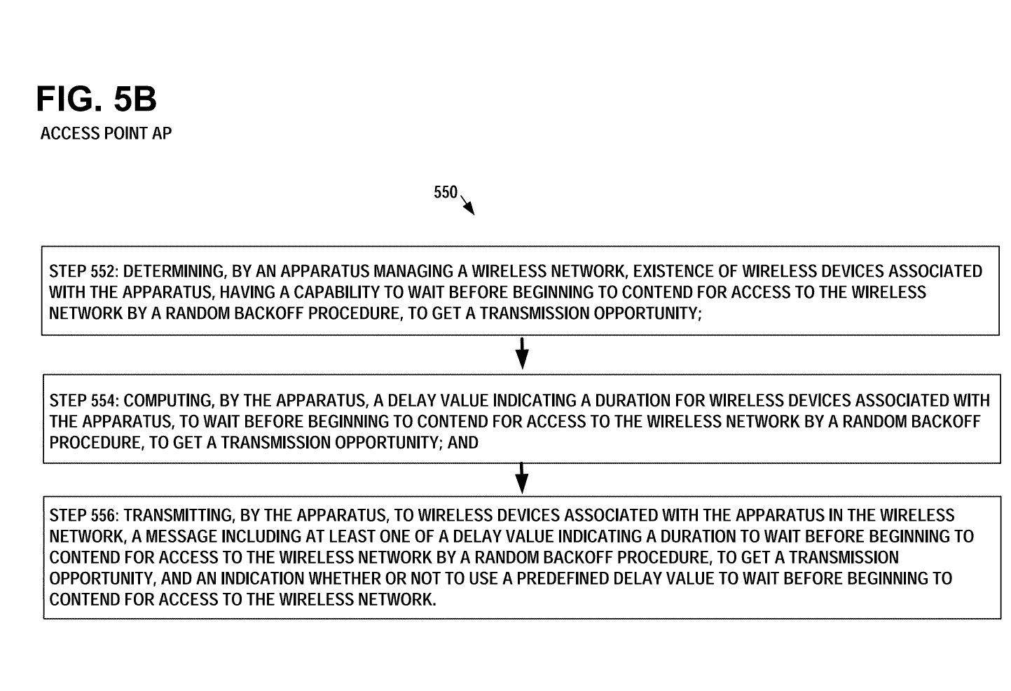

FIG. 5A is an example flow diagram 500 of operational steps in a wireless device 1A that has a capability to wait before beginning to contend for access to the wireless network by a random backoff procedure, to get a transmission opportunity, in accordance to an example embodiment of the invention. The steps of the flow diagram represent computer code instructions stored in the RAM and/or ROM memory of the device, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 502: receiving, by an apparatus, a message from an access node managing a wireless network to which the apparatus is associated, the message including at least one of a delay value indicating a duration to wait before beginning to contend for access to the wireless network by a random backoff procedure to get a transmission opportunity, and an indication whether or not the apparatus is to use a predefined delay value to wait before beginning to contend for access to the wireless network;

Step 504: determining, by the apparatus, whether to use the delay value to wait before beginning to contend for access to the wireless network, based on at least one of a type of the apparatus, a type of service the apparatus performs, and the indication from the access node whether or not the apparatus is to use the delay value;

Step 506: waiting, by the apparatus, for a duration represented by the delay value, when the apparatus has data to transmit over the wireless network, in response to determining to use the delay value; and

Step 508: beginning, by the apparatus, to contend for access to the wireless network by a random backoff procedure after the wait duration, before initiating transmission.

FIG. 5B is an example flow diagram 550 of operational steps in the access node that computes a delay value indicating a duration for wireless devices associated with the access node, to wait before beginning to contend for access to the wireless network by a random backoff procedure, to get a transmission opportunity, according to an example embodiment of the invention. The steps of the flow diagram represent computer code instructions stored in the RAM and/or ROM memory of the device, which when executed by the central processing units (CPU), carry out the functions of the example embodiments of the invention. The steps may be carried out in another order than shown and individual steps may be combined or separated into component steps. Additional steps may be included in this sequence. The steps of the example method are as follows.

Step 552: determining, by an apparatus managing a wireless network, existence of wireless devices associated with the apparatus, having a capability to wait before beginning to contend for access to the wireless network by a random backoff procedure, to get a transmission opportunity;

Step 554: computing, by the apparatus, a delay value indicating a duration for wireless devices associated with the apparatus, to wait before beginning to contend for access to the wireless network by a random backoff procedure, to get a transmission opportunity; and

Step 556: transmitting, by the apparatus, to wireless devices associated with the apparatus in the wireless network, a message including at least one of a delay value indicating a duration to wait before beginning to contend for access to the wireless network by a random backoff procedure, to get a transmission opportunity, and an indication whether or not to use a predefined delay value to wait before beginning to contend for access to the wireless network.

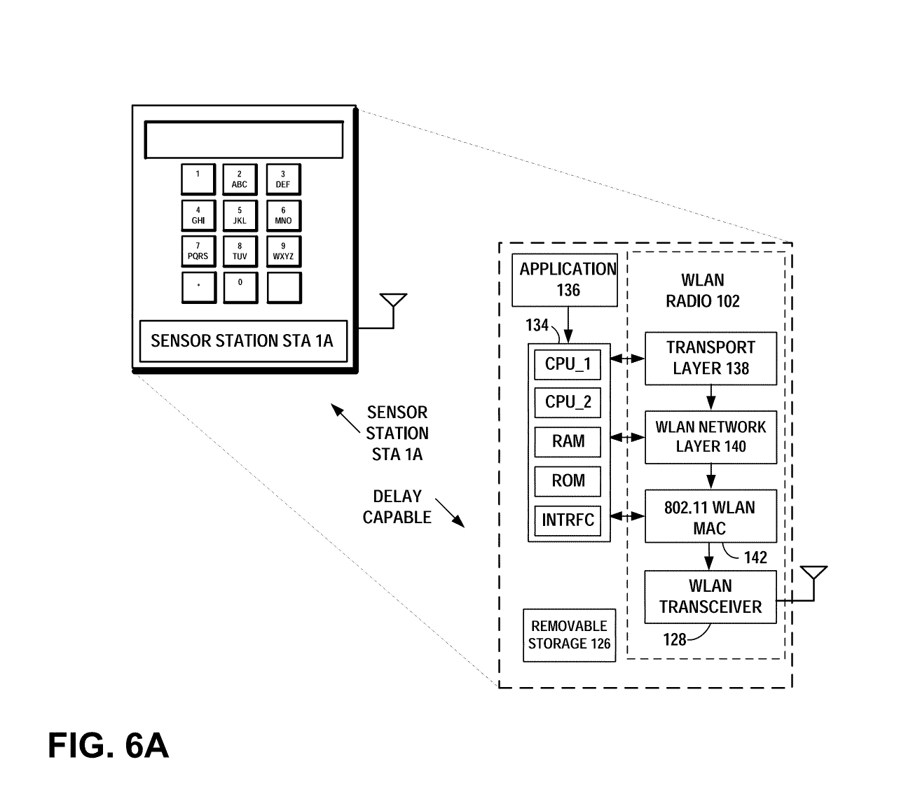

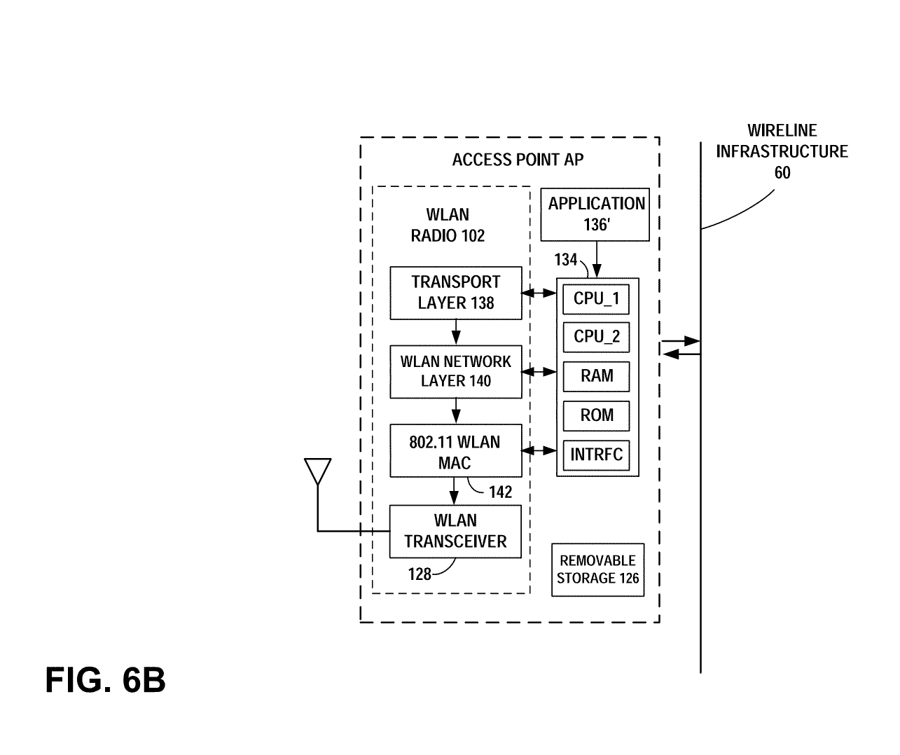

FIG. 6A is an example functional block diagram, illustrating an example wireless device 1A, according to an example embodiment of the invention. The example wireless device 1A may include a processor 134 that may include at least one of the following: a dual or multi-core central processing unit CPU_1 and CPU_2, a RAM memory, a ROM memory, and an interface for a keypad, display, and other input/output devices. The example wireless device may include a WLAN protocol stack, including the IEEE 802.11 MAC 142, which may be based, for example, on the IEEE 802.11ah WLAN standard for communication with the AP over the network BSS. The WLAN protocol stack may also include a network layer 140, a transport layer 138, and an application program 136.

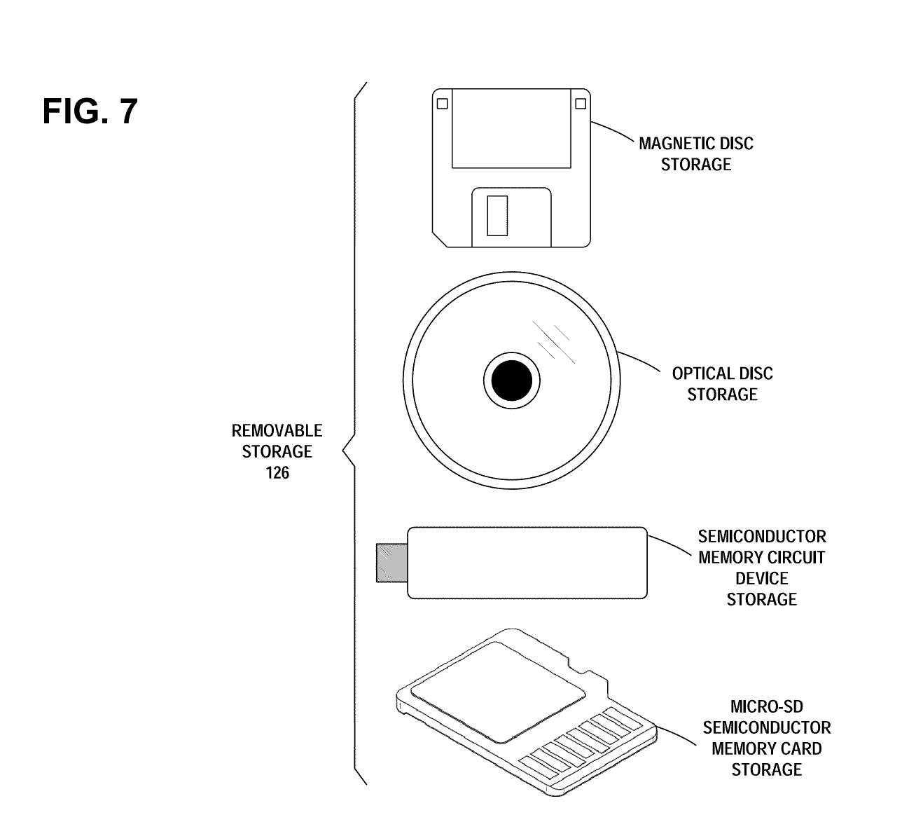

In an example embodiment, the interface circuits in FIG. 6A may interface with one or more radio transceivers, battery and other power sources, key pad, touch screen, display, microphone, speakers, ear pieces, camera or other imaging devices, etc. The RAM and ROM may be removable memory devices 126 such as smart cards, SIMs, WIMs, semiconductor memories such as RAM, ROM, PROMS, flash memory devices, etc. The processor protocol stack layers, and/or application program may be embodied as program logic stored in the RAM and/or ROM in the form of sequences of programmed instructions which, when executed in the CPU, carry out the functions of example embodiments. The program logic may be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The one or more radios in the device may be separate transceiver circuits or alternately, the one or more radios may be a single RF module capable of handling one or multiple channels in a high speed, time and frequency multiplexed manner in response to the processor. An example of removable storage media 126, as shown in FIG. 7, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

FIG. 6B is an example functional block diagram, illustrating an example access point or node AP connected to a wireline infrastructure 60, according to an example embodiment of the invention. The example access point or node AP may include a processor 134 that may include at least one of the following: a dual or multi-core central processing unit CPU_1 and CPU_2, a RAM memory, a ROM memory, and an interface for a keypad, display, and other input/output devices. The example wireless device may include a WLAN protocol stack, including the IEEE 802.11 MAC 142, which may be based, for example, on the IEEE 802.11ah WLAN standard for communication with the AP over the network BSS. The WLAN protocol stack may also include a network layer 140, a transport layer 138, and an application program 136′. An example of removable storage media 126, as shown in FIG. 7, may be based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

FIG. 7 illustrates an example embodiment of the invention, wherein examples of removable storage media 126 are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

In an example embodiment of the invention, wireless networks may include other sensor type networks and/or other networks having a large number of supported stations/apparatuses. Examples of such networks include, for example cellular systems such as Global System for Mobile Communications (GSM), Wideband Code Division Multiple Access (W-CDMA), High Speed Packet Access (HSPA), Long Term Evolution (LTE), LTE Advanced (LTE-A), International Mobile Telecommunications Advanced (IMT-A), CDMA, Wireless Metropolitan Area Networks (WMAN) and Broadband Wireless Access (BWA) (LMDS, WiMAX, AIDAAS and HiperMAN), or the like networks, as well as short range networks such as Bluetooth, Zigbee, IEEE 802.11, Digital Enhanced Cordless Telecommunications (DECT), HiperLAN, Radio Frequency Identification (RFID), Wireless USB, DSRC (Dedicated Short range Communications), Near Field Communication, wireless sensor networks, EnOcean; TransferJet, Ultra-wideband (UWB from WiMedia Alliance), WLAN, WiFi, and HiperLAN.

In accordance with an example embodiment of the invention, the STAs may be, for example, a miniature device such as a key fob, smart card, jewelry, or the like. The STAs may be, for example, a larger device such as a cell phone, smart phone, flip-phone, PDA, graphic pad, or even larger devices such as a laptop computer, an automobile, and the like.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable non-transitory media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable non-transitory medium.

As indicated above, memory/storage devices include, but are not limited to, disks, optical disks, removable memory devices such as smart cards, SIMs, WIMs, semiconductor memories such as RAM, ROM, PROMS, etc. Transmitting media include, but are not limited to, transmissions via wireless communication networks, the Internet, intranets, telephone/modem-based network communication, hard-wired/cabled communication network, satellite communication, and other stationary or mobile network systems/communication links.

Although specific example embodiments of the invention have been disclosed, a person skilled in the art will understand that changes can be made to the specific example embodiments without departing from the spirit and scope of the invention.

What is claimed is:

1. A method, comprising:
receiving, by an apparatus, a message from an access node managing a wireless network to which the apparatus is associated, the message including at least one of a delay value indicating a duration to wait before beginning to contend for access to the wireless network by a random backoff procedure to get a transmission opportunity, and an indication whether or not the apparatus is to use a predefined delay value to wait before beginning to contend for access to the wireless network;
determining, by the apparatus, whether to use the delay value to wait before beginning to contend for access to the wireless network, based on at least one of a type of the apparatus, a type of service the apparatus performs, and the indication from the access node whether or not the apparatus is to use the delay value;
waiting, by the apparatus, for a duration represented by the delay value, when the apparatus has data to transmit over the wireless network, in response to determining to use the delay value; and
beginning, by the apparatus, to contend for access to the wireless network by a random backoff procedure after the wait duration, before initiating transmission.

2. The method of claim 1, further comprising:
computing, by the apparatus, a randomized delay value based on the received delay value.

3. The method of claim 1, further comprising:
transmitting, by the apparatus, a message to the access node, including an indication that the apparatus has a capability to wait before beginning to contend for access to the wireless network by a random backoff procedure, to get a transmission opportunity.

4. The method of claim 1, wherein the message from the access node is at least one of a broadcast message, groupcast message, unicast message, beacon, probe response, public action frame, wireless network management frame, association response frame, and reassociation response frame.

5. A method, comprising:
determining, by an apparatus managing a wireless network, existence of wireless devices associated with the apparatus, having a capability to wait before beginning to contend for access to the wireless network by a random backoff procedure, to get a transmission opportunity;
computing, by the apparatus, a delay value indicating a duration for wireless devices associated with the apparatus, to wait before beginning to contend for access to the wireless network by a random backoff procedure, to get a transmission opportunity; and
transmitting, by the apparatus, to wireless devices associated with the apparatus in the wireless network, a message including at least one of a delay value indicating a duration to wait before beginning to contend for access to the wireless network by a random backoff procedure, to get a transmission opportunity, and an indication whether or not to use a predefined delay value to wait before beginning to contend for access to the wireless network.

6. The method of claim 5, further comprising:
computing, by the apparatus, the delay value, based on at least one of wireless network load, statistics related to successful transmissions in the wireless network, and service type of the wireless devices associated with the apparatus.

7. The method of claim 6, further comprising:
computing, by the apparatus, a revised delay value, based on at least one of a revised wireless network load and revised statistics related to successful transmissions in the wireless network; and
transmitting, by the apparatus, a message including the revised delay value, to wireless devices associated with the apparatus in the wireless network.

8. The method of claim 5, further comprising:
computing, by the apparatus, the delay value, based at least on providing a fair share of network capacity to wireless devices associated with the apparatus in the wireless network.

9. An apparatus, comprising:
at least one processor;
at least one memory including computer program code;
the at least one memory and the computer program code configured to, with the at least one processor, cause the apparatus at least to:
receive a message from an access node managing a wireless network to which the apparatus is associated, the message including at least one of a delay value indicating a duration to wait before beginning to contend for access to the wireless network by a random backoff procedure to get a transmission opportunity, and an indication whether or not the apparatus is to use a predefined delay value to wait before beginning to contend for access to the wireless network;
determine whether to use the delay value to wait before beginning to contend for access to the wireless network, based on at least one of a type of the apparatus, a type of service the apparatus performs, and the indication from the access node whether or not the apparatus is to use the delay value;
wait for a duration represented by the delay value, when the apparatus has data to transmit over the wireless network, in response to determining to use the delay value; and
begin to contend for access to the wireless network by a random backoff procedure after the wait duration, before initiating transmission.

10. The apparatus of claim 9, further comprising:
the at least one memory and the computer program code configured to, with the at least one processor, cause the apparatus at least to:
compute a randomized delay value based on the received delay value.

11. The apparatus of claim 9, further comprising:
the at least one memory and the computer program code configured to, with the at least one processor, cause the apparatus at least to:
transmit a message to the access node, including an indication that the apparatus has a capability to wait before beginning to contend for access to the wireless network by a random backoff procedure, to get a transmission opportunity.

12. The apparatus of claim 9, wherein the message from the access node is at least one of a broadcast message, groupcast message, unicast message, beacon, probe response, public action frame, wireless network management frame, association response frame, and reassociation response frame.

13. An apparatus, comprising:
at least one processor;
at least one memory including computer program code;
the at least one memory and the computer program code configured to, with the at least one processor, cause the apparatus at least to:
determine existence of wireless devices associated with the apparatus managing a wireless network, having a capability to wait before beginning to contend for access to the wireless network by a random backoff procedure, to get a transmission opportunity;
compute a delay value indicating a duration for wireless devices associated with the apparatus, to wait before beginning to contend for access to the wireless network by a random backoff procedure, to get a transmission opportunity; and
transmit a message including the delay value, to wireless devices associated with the apparatus in the wireless network, the message including at least one of a delay value indicating a duration to wait before beginning to contend for access to the wireless network by a random backoff procedure, to get a transmission opportunity, and an indication whether or not to use a predefined delay value to wait before beginning to contend for access to the wireless network.

14. The apparatus of claim 13, further comprising:
the at least one memory and the computer program code configured to, with the at least one processor, cause the apparatus at least to:
compute the delay value, based on at least one of wireless network load, statistics related to successful transmissions in the wireless network, and service type of the wireless devices associated with the apparatus.

15. The apparatus of claim 14, further comprising:
the at least one memory and the computer program code configured to, with the at least one processor, cause the apparatus at least to:
compute a revised delay value, based on at least one of a revised wireless network load and revised statistics related to successful transmissions in the wireless network; and
transmit a message including the revised delay value, to wireless devices associated with the apparatus in the wireless network.

16. The apparatus of claim 13, further comprising:
the at least one memory and the computer program code configured to, with the at least one processor, cause the apparatus at least to:
compute the delay value, based at least on providing a fair share of network capacity to wireless devices associated with the apparatus in the wireless network.

17. A computer program product comprising computer executable program code recorded on a computer readable, non-transitory storage medium, the computer executable program code comprising:
code for receiving, by an apparatus, a message from an access node managing a wireless network to which the apparatus is associated, the message including at least one of a delay value indicating a duration to wait before beginning to contend for access to the wireless network by a random backoff procedure to get a transmission opportunity, and an indication whether or not the apparatus is to use a predefined delay value to wait before beginning to contend for access to the wireless network;
code for determining, by the apparatus, whether to use the delay value to wait before beginning to contend for access to the wireless network, based on at least one of a type of the apparatus, a type of service the apparatus performs, and the indication from the access node whether or not the apparatus is to use the delay value;
code for waiting, by the apparatus, for a duration represented by the delay value, when the apparatus has data to transmit over the wireless network, in response to determining to use the delay value; and
code for beginning, by the apparatus, to contend for access to the wireless network by a random backoff procedure after the wait duration, before initiating transmission.

18. The computer program product of claim 17, further comprising:
code for transmitting, by the apparatus, a message to the access node, including an indication that the apparatus has a capability to wait before beginning to contend for access to the wireless network by a random backoff procedure, to get a transmission opportunity.

19. A computer program product comprising computer executable program code recorded on a computer readable, non-transitory storage medium, the computer executable program code comprising:
code for determining, by an apparatus managing a wireless network, existence of wireless devices associated with the apparatus, having a capability to wait before beginning to contend for access to the wireless network by a random backoff procedure, to get a transmission opportunity;
code for computing, by the apparatus, a delay value indicating a duration for wireless devices associated with the apparatus, to wait before beginning to contend for access to the wireless network by a random backoff procedure, to get a transmission opportunity; and
code for transmitting, by the apparatus, to wireless devices associated with the apparatus in the wireless network, a message including at least one of a delay value indicating a duration to wait before beginning to contend for access to the wireless network by a random backoff procedure, to get a transmission opportunity, and an indication whether or not to use a predefined delay value to wait before beginning to contend for access to the wireless network.

20. The computer program product of claim 19, further comprising:
code for computing, by the apparatus, the delay value, based on at least one of wireless network load, statistics related to successful transmissions in the wireless network, and service type of the wireless devices associated with the apparatus.
